(19) United States
(12) Patent Application Publication
(10) Pub. No.: US 2026/0024121 A1
(43) Pub. Date: Jan. 22, 2026

(54) USAGE BASED SMART CONFIGURATION ANALYZER FOR RIGHT SIZING AND SUSTAINABILITY

(71) Applicant: Dell Products L.P., Round Rock, TX (US)

(72) Inventors: Rajiv Popat, Kolkata (IN); Irfan Gilani, Cedar Park, TX (US); Gopinath Kandhadi, Austin, TX (US)

(73) Assignee: Dell Products L.P., Round Rock, TX (US)

(21) Appl. No.: 18/775,360

(22) Filed: Jul. 17, 2024

(51) Int. Cl. G06Q 30/0601

(52) U.S. Cl. CPC G06Q 30/0629; G06Q 30/0631; G06Q 30/0633

(57) ABSTRACT

A method, comprising: identifying a first application set which a user intends to run on a hardware configuration; identifying a first hardware configuration; detecting whether the first hardware configuration is overpowered with respect to the first application set; when the first hardware configuration is overpowered, identifying a second hardware configuration based on the first application set, and completing a first action based on the second hardware configuration; and when the first hardware configuration is not overpowered, completing a second action based on the first hardware configuration.

### BACKGROUND

Computer system retailers are often presented with a set of customer requirements, and tasked with identifying and offering a computing system that meets a predetermined set of customer requirements. Identifying a computing system that satisfies the customer requirements could be a challenging task that is critical to the successful closing of a sale. Furthermore, correctly identifying a computing system that meets the customer requirements could be critical to continued customer satisfaction with the system, after the system is sold.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided, comprising: identifying a first application set which a user intends to run on a hardware configuration; identifying a first hardware configuration; detecting whether the first hardware configuration is overpowered with respect to the first application set; when the first hardware configuration is overpowered, identifying a second hardware configuration based on the first application set, and completing a first action based on the second hardware configuration; and when the first hardware configuration is not overpowered, completing a second action based on the first hardware configuration.

According to aspects of the disclosure, a method is provided comprising: identifying a plurality of first hardware configurations that are associated with an institution; identifying a plurality of application sets, each of the application sets being executed on a different one of the plurality of first hardware configurations; clustering the plurality of application sets to produce a plurality of clusters; combining the application sets in any of the clusters to produce a composite application set; identifying a second hardware configuration based on the composite application set; and completing an action based on the second hardware configuration.

According to aspects of the disclosure, a method is provided comprising: identifying a first application set; identifying a plurality of second application sets that each include a predetermined number of applications in common with the first application set; identifying an application that is part of a predetermined number of the second application sets, but not of the first application set; adding the identified application to the first application set; identifying a hardware configuration based on the first application set; and completing an action based on the hardware configuration.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2A is a diagram of an example of a table, according to aspects of the disclosure;

FIG. 2B is a diagram of an example of a table, according to aspects of the disclosure;

FIG. 3 is a diagram of an example of an agent, according to aspects of the disclosure;

FIG. 4 is a diagram of an example of a manager, according to aspects of the disclosure;

FIG. 5 is a flowchart of an example of a process, according to aspects of the disclosure;

FIG. 6 is a flowchart of an example of a process, according to aspects of the disclosure;

FIG. 7 is a flowchart of an example of a process, according to aspects of the disclosure;

FIG. 8A is a flowchart of an example of a process, according to aspects of the disclosure;

FIG. 8B is a flowchart of an example of a process, according to aspects of the disclosure;

FIG. 8C is a flowchart of an example of a process, according to aspects of the disclosure; and

FIG. 9 is a diagram of an example of a computing device, according to aspects of the disclosure.

### DETAILED DESCRIPTION

For years people have followed a “guestimate” based approach when ordering client-side hardware (and even server-side hardware). Most purchase on the consumer side today mainly happens on the perceived needs of people—i.e., people buy devices with configuration based on what they ‘think’ they need.

For example, most elderly people buying a laptop think they need a laptop with an Intel Core i5 ™ processor, when in reality all they plan on using the laptop is for web browsing with a little bit of Microsoft Word™. Similarly, most college-going students often end up buying MacBooks and laptops with configurations which are way higher than their regular demands.

In this day and age, customers buying processing power that they never end up using is a genuine problem which is compounded by social media influencers creating constant content and reviews promoting the latest and the greatest gadget out there. Today, a lot of students falsely believe that they need a high-end Intel Core i7 ™ laptop just to take notes for their classes. The tablets sold under the brand names iPad Pro™ and iPad Air™ are a classic example of a device that has more hardware bundled in it than what most students really require. Even though there are articles in the media that attempt to educate users that iPads with an M2 chip are an overkill for most users and that most iPad applications are (even today) not able to fully utilize the 45% increased processing power that the M2 chips provided, students continue to feel they need the latest iPads.

Buying overpowered devices may hurt sustainability. The difference between buying an Intel Core i7 ™ processor, when one needs a low-powered Celeron™ processor to do some basic Microsoft Office work, can be 60 kilograms of extra carbon emission every year. Even a small increase of 10 W of power consumption between CPU and GPU can further lead to up to 29 Kilograms of additional carbon emissions every year.

The other side of the spectrum also includes customers buying cheaper devices to save money and then having low satisfaction from those devices because of the devices failing to deliver on their customers' requirements—i.e., because of the devices not being able to run effectively the applications the customers need. In this scenario, buying low-end devices can lower the customer's overall trust and perception of the vendor from which the low-end devices are purchased, in addition to the customer having to spend more money to buy yet another device which this time hopefully meets the customer's needs.

Problems of wrong-sizing are further compounded when these devices are purchased in bulk by institutions. Take for example a university that provides laptops to all the students who join their resident MBA Program. Because all these students are only going to work with Microsoft Office™ for most of their tenure, providing them high-end machines with Intel Core i7 ™ CPUs and high-end graphics cards may not make sense from both economic and ecological perspectives. On the other end, giving them under-powered machines will result in impacting the education of students and the overall reputation of the university. The university, in this case, might benefit from a real objective measure of what is realistically the right configuration of a laptop to distribute to students, which can draw a pragmatic balance between cost and productivity, as well as a balance between sustainability and productivity, while providing students with hardware that is neither over-utilized nor underutilized given their day-to-day usage.

Oftentimes, many people and institutions rely on reviews by experts and social media influencers to choose the computing system that is right for them. However, this approach is sub-optimal as such experts and social media influencers may have a conflict of interest (because they receive benefits from the vendors of the computing systems they review) or even lack sufficient expertise. Accordingly, the need exists for a more structured approach that is capable of analyzing a customer's needs and providing a reliable recommendation as to what computing system configuration the customer should pick, which would neither be overpowered nor underpowered given the customer's needs.

The present disclosure provides a new, practical, data-driven approach to estimating a computing system configuration that an individual/organization will need so that: (1) the individual/organization does not end up spending more than they need to, and (2) the individual/organization does not end up purchasing an underpowered device that would impact their productivity and ruin the vendor's reputation in the long run.

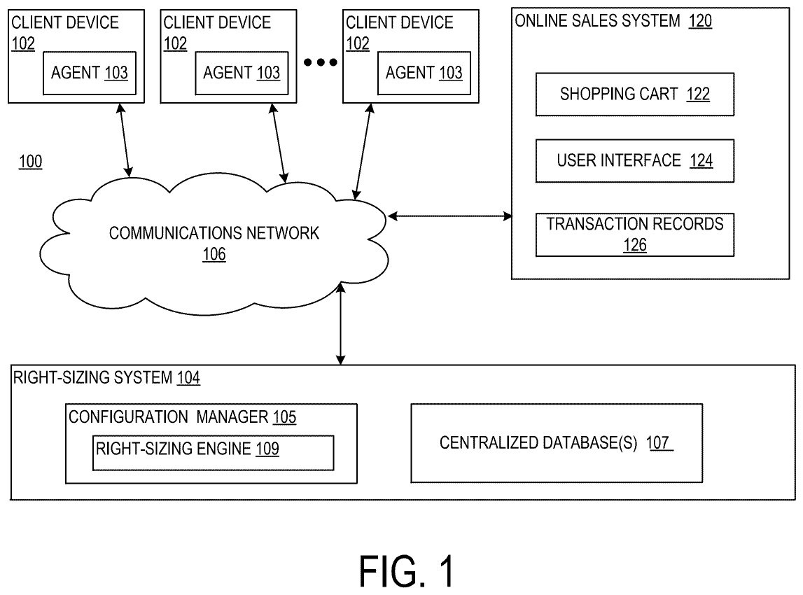

The present disclosure proposes a smart configuration manager (e.g., manager 105, shown in FIG. 1) for computing devices that can recommend a right-sized computing system configuration based on real-world community usage data. In some implementations, the configuration manager may provide dynamic ever-evolving “intent-based configuration” where users can ask fundamental questions like, “Can you recommend a laptop for playing Fortnite, Call of Duty, Running Tensor Flow and Visual Studio?” and the configuration manager can recommend the most optimized configuration for the same. The configuration manager may also allow a dynamic map between specific configurations and intentions by allowing users to ask questions like “Will this laptop be able to run Photoshop?”.

In one example, the configuration manager may utilize an agent (e.g., agent 103, shown in FIG. 1) that the users can install on their computing devices (e.g., on their laptops, desktops, smartphones, internet-of-things (IoT) devices, gaming consoles, etc.). The agent may collect data relating to the usage of the user's computing devices, including which applications are being used, how effectively the hardware is able to run the applications, how optimized the computing devices' power consumption is, etc. All of this data may then be spooled over to one or more centralized databases (e.g., see database 107, shown in FIG. 1). Alternatively, in some implementations, the agent may be preloaded as a driver in the default configuration of laptops that are sold by a vendor (provided that the user consents). This will enable the vendor to install the agent at a mass level and collect large amount of right-sizing data.

The configuration manager may provide a self-evolving community-driven intent-based solution, which can help end-users purchase a computing system, whose hardware configuration most closely matches the end user's needs. The configuration manager may use the data that is uploaded to the one or more centralized databases provide direct configuration recommendations using collective community data. The configuration manager may create a pre-configured quote for the customer which matches their exact requirements, instead of relying on manual work by a salesperson or the end user themselves. The result of course can be reviewed and further improved by a human expert, but this may not be necessary in many cases. The configuration manager may add massive cost savings to the operations of computing system vendors as it may reduce the time spent by human experts on analyzing customers' needs and making corresponding recommendations for computing systems hardware configurations that would meet the customers' needs.

The term “hardware configuration” as used throughout the disclosure refers to one or more hardware specification values. For example, a hardware configuration may specify one or more a type of processor (e.g., Intel Core 15™), a type of random-access memory (e.g., DDR5), and a random-access memory size (e.g., 8 GB). The term indication of hardware configuration may refer to one or more of a number, string, alphanumerical string, image, or sound that at least in part indicative of a hardware configuration. For instance, the string “CoreI5; 8 GB DDR5” is one possible example of an indication of a hardware configuration. As another example, the string “DELL Inspiron 1340” is another example of an indication of a hardware configuration, where “DELL Inspiron 1340” is an identifier of the model of a computing that possesses the hardware configuration from the above example (i.e., Core I5; 8 GB DDR5). In other words, a hardware configuration may also be indicated by the model number (or another identifier) that belongs to a computing device possessing the hardware configuration. When permitted by context, the terms “hardware configuration” and “computing device” are used interchangeably. For example, the phrase “adding a hardware configuration to a shopping cart” means that a computing device possessing the hardware configuration is added to the shopping cart. As is discussed further below, a manager 105 is provided that can identify a hardware configuration for a particular user. In this regard, the phrase “manager 105 outputs an indication of a hardware configuration (or other information)” means that the manager 105 can take any action that would result in the hardware configuration (or other information) being present to the user. For instance, the action may include displaying the indication or other information a display device and/or transmitting the indication or other information over a communications network, to a remote device, for presentation of the user of the remote device.

FIG. 1 is a diagram of an example of a system 100, according to aspects of the disclosure. As illustrated, system 100 may include a plurality of client devices 102 (hereinafter “devices 102”), a configuration system 104 (hereinafter “system 104) and an online sales system 120 (hereinafter “system 120”). As illustrated, devices 102, system 104, and system 120 may be coupled to each other via a communications network 106. Network 106 may include any suitable type of communications network, such as a wireless network, a local area network (LAN), a wide area network (WAN), and the Internet.

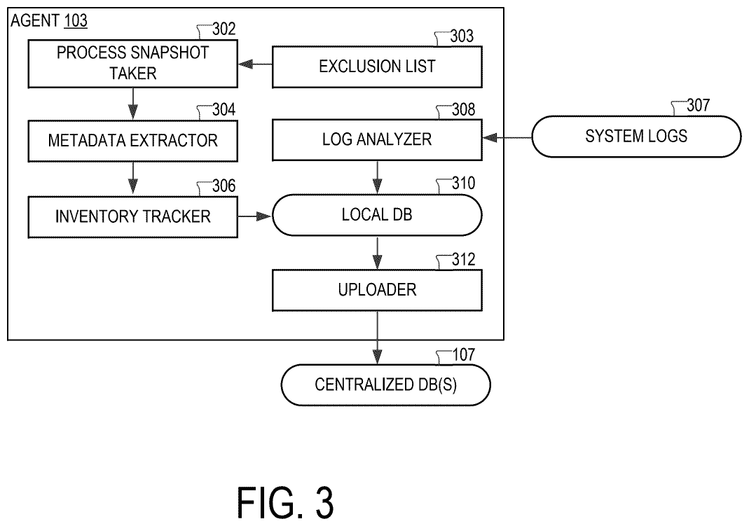

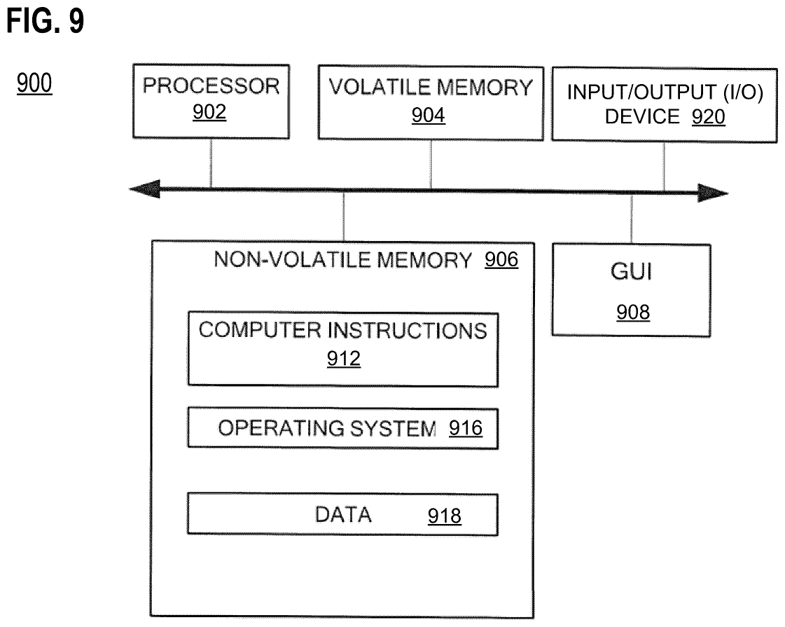

Each of devices 102 may include a computing device, such as the computing device 900 which is discussed further below with respect to FIG. 9. Any of computing devices 102 may include a laptop computer, a desktop computer, a smartphone, an IoT device, and/or any other suitable type of computing device. Each of the computing devices 102 may be configured to execute an agent 103. Agent 103, which is executed on any given device 102, may collect hardware utilization metrics and/or software performance metrics that can be used by system 104 to detect how fast the given device 102 is able to execute the software installed on it. The operation of agent 103 is discussed further below with respect to FIG. 3.

System 104 may include one or more computing devices, such as the computing device 900, which is discussed below with respect to FIG. 9. System 104 may be configured to execute a configuration manager 105 (hereinafter “manager 105”). Manager 105 may execute a right-sizing engine (hereinafter “engine 109”) and one or more centralized databases 107 (hereinafter “database 107”). Engine 109 may receive data that is collected by agents 103 and store the data in database 107. Furthermore, engine 109 may tag the data that is stored in database 107. And still furthermore, engine 109 may process the stored data and tags to make a recommendation for the hardware configuration of a computing system that a customer may be willing to purchase. The recommendation may be made in the context of the customer accessing system 120 or visiting a brick-and-mortar store.

The system 120 may include any suitable type of online sales system. System 120 may include one or more computing devices, such as the computing device 900 which is discussed further below with respect to FIG. 9. System 120 may implement a shopping cart 122 and a user interface 124. In addition, system 120 may store one or more transaction records 126. Although, in the present example, system 120 is an online sales system. Alternative implementations are possible in which system 120 is a system that is used internally by a vendor for the placement or management of purchase orders, etc. In other words, system 120 may or may not be a system that is available to customers.

Shopping cart 122 may include any suitable type of shopping cart software. Shopping cart 122 may allow users to add or remove items they are willing to purchase and adjust the number of units of each item. In addition, shopping cart 122 may provide a price calculation service, a service that implements a checkout process, and an order tracking service. The service that provides the checkout process may facilitate the final steps of a purchase, such as entering shipping details, selecting payment methods, and confirming an order.

The user interface 124 may be similar to the user interface of any online saving platform. The user interface 124 may include one or more product pages. Each product page may include information about a respective product and an “add to cart button,” which when activated causes the respective product to be added to the user's shopping cart. The user interface 124 may include one or more screens for accessing shopping cart 122, which show what information is present in the shopping cart and/or enable the user to enter payment and shipping information. The present disclosure is not limited to any specific configuration of user interface 124.

The transaction records 126 may be stored in the memory of system 120 or elsewhere. Each transaction record may include all (or at least some) of the information that is collected or generated over the course of the user accessing the shopping system. The information may be stored in or more databases that are part of system 120. The term “record” as used in the phrase “transaction record” is not intended to imply that the information that constitutes the transaction record is stored in the same file or data structure. The information that constitutes the transaction record may be dispersed across multiple storage locations. In one example, a transaction record may be specific to a particular session, and it may be updated as the user interacts with shopping cart 122 and user interface 124. For example, when the user adds a hardware configuration to the shopping cart, the transaction record may be updated to include an identifier of the hardware configuration. Similarly, when the user enters payment information or a shipping address, the transaction record may be updated to include this information as well.

In some implementations, manager 105 may perform one or more of the following functions. For instance, manager 105 (together with agents 103) may monitor and profile the usage of user's computing devices to determine if their current hardware is being underutilized or overutilized for the typical usage of their owner. Additionally or alternatively, manager 105 (together with agents 103) may collect application inventory, application metadata, application usage and telemetry data over time and spool it to database 107 for further analysis. Additionally or alternatively, manager 105 may provide purchasing recommendations for desktop and laptop computers based on real usage and by understanding the intention of the user buying the device about what software they plan to run on the device. Additionally or alternatively, manager 105 may build a database of configuration to intention mapping. For example, if a new game is released in the market, assuming that agent 103 is installed on a number of laptops, manager 105 should be able to gather data about which laptops have the ability to comfortably run the game with less than N % CPU utilization and which other laptops are struggling to play the game. Additionally or alternatively, for point of sale (POS), assisted point of sale (APOS), and upgrade purchases, manager 105 may provide a direct creation of solutions (pre-configured cart that can be converted to a quote/order) based on the usage patterns on an existing device that is being upgraded. Additionally or alternatively, manager 105 may provide a queryable interface where people can enter a list of their intentions for buying a device in natural language, and based on their intentions entered, manager 105 will be able to propose the most optimum configuration, family, make and/or model of the laptop/desktop that they might want to buy. The recommendation will be optimized to take into consideration the intentions, cost, and sustainability. The statement of intentions that is provided by the user may include one or more of (1) a list of applications the user is expecting to run on the device that the user is looking to purchase and/or (2) a list of activities the user intends to use the device for, such as word processing, gaming, Internet browsing, and cad design.

In some implementations, manager 105 may be integrated with user interface 124. Additionally or alternatively, manager 105 may be arranged to receive user input via interface 124 and/or output information via interface 124. However, it will be understood that manager 105 is not limited to using any specific type of user interface.

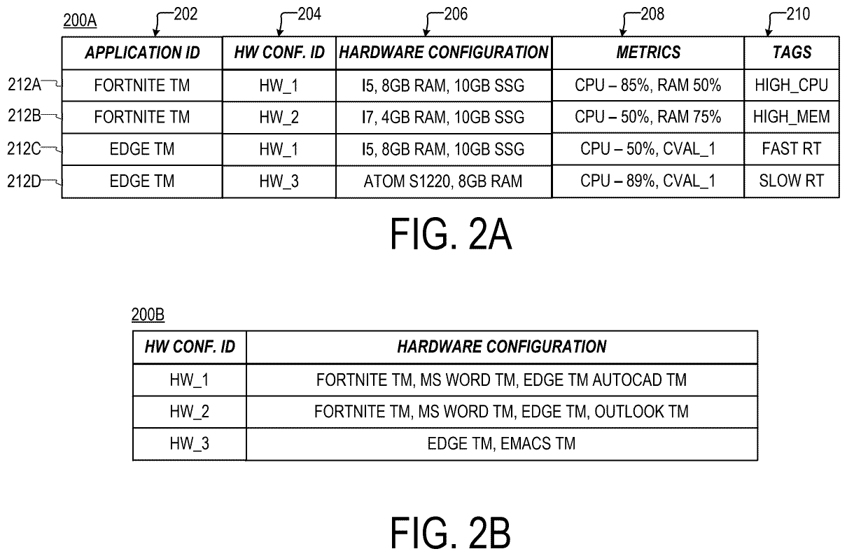

FIG. 2A shows an example of a table 200A. Table 200A may be a database table that is stored in any of database 107 and/or a table that is compiled by manager 105 by querying database 107. Table 200A may include rows 212. Each row 212 may include fields 202-210. Field 202 includes an identifier of an application. Field 204 includes a hardware configuration identifier. The hardware configuration identifier may be any number or string that identifies a particular computing device. By way of example, the hardware configuration identifier may identify the family, make, and model of the computing device. Additionally or alternatively, the hardware configuration identifier may include an identifier that is unique to the computing device and which can be used to distinguish the computing device from other devices of the same family, make, and model. Additionally or alternatively, the hardware configuration identifier may identify a user of the corresponding hardware configuration. Additionally or alternatively, the hardware configuration identifier may identify an institution (e.g., a university or corporation, etc.) that is associated with the corresponding hardware configuration. Field 206 may identify the hardware configuration of the computing device identified in field 204. Field 206 may identify one or more components that are part of the computing device. For example, field 206 may identify one or more of: (i) type and speed of processor that is part of the computing device, (ii) the type and amount of memory available in the computing device, and so forth. Field 208 may store one or more hardware utilization metrics that are collected from the computing device identified in field 204. Additionally or alternatively, field 208 may identify one or more counter values that are collected from the computing device identified in field 208. Field 210 may include one or more tags that are generated by manager 105 based on information contained in field 210.

The term “tag” as used herein may include any number or string that is at least in part indicative of how suitable a hardware configuration is for running a particular application. For example, a tag may indicate that the application is straining the hardware configuration, and thus non-suitable. For instance, when field 208 indicates that the CPU utilization for a particular application is 85%, this is an indication that the application is straining the processor, and under such circumstances, the tag may indicate that the hardware configuration is not suitable for running the application. As another example, a tag may indicate that the hardware configuration is overkill for running the application, and thus non-suitable. For instance, when field 208 indicates that the CPU utilization for a particular application is 1%, this is an indication that the processor is way too fast for what the application needs, and under such circumstances, the tag may indicate that the hardware configuration is not suitable for running the application. As another example, a tag may indicate that the hardware configuration is just right (i.e., adequate) for running the application, and thus suitable. For instance, when field 208 indicates that the CPU utilization for a particular application is 25%, this is an indication that the processor is well-suited to run the application, and under such circumstances, the tag may indicate that the hardware configuration is adequate for running the application. As another example, a tag that is part of a given row 212 may indicate the activity which the application that is identified in field 202 of the same given row 212 may be used for. In some implementations, a tag in a given row 212 may indicate whether the CPU usage, memory usage, or another resource usage, of the application that is identified in field 202 of the given row 212 indicates that the hardware configuration associated with the given row 212 (i.e., identified in field 204) is underpowered, overpowered, or adequate for running the application (identified in field 202 of the given row 212).

In the example of FIG. 2A, row 212A indicates that when hardware configuration HW_1 is running Fortnite™, the CPU utilization is 85% and the memory utilization is 50%. Row 212A includes a tag that the CPU utilization is considered high (which is an indication that hardware configuration HW_1 is not suitable to run Fortnite™). In addition, row 212A identifies specific hardware components and/or component specifications that make up hardware configuration HW1. Row 212B indicates that when hardware configuration HW_2 is running Fortnite™, the CPU utilization is 50% and the memory utilization is 85%.

Row 212B includes a tag that memory CPU utilization is considered high (which is an indication that hardware configuration HW_2 is not suitable to run Fortnite™). In addition, row 212B identifies specific hardware components and/or component specifications that make up hardware configuration HW_2.

Row 212C indicates that when hardware configuration HW_1 is running Edge™, the CPU utilization is 20%. In addition, field 208 of row 212C includes a first counter value CVAL_1 which indicates the response time of Edge™ and field 210 of row 212C includes a tag that is generated based on CVAL_1, which indicates that hardware configuration HW_1 has a fast response time with respect to Edge™. In addition, in field 208, row 212C identifies specific hardware components and/or component specifications that make up hardware configuration HW_1.

Row 212D indicates that when hardware configuration HW_3 is running Edge™, the CPU utilization is 89%. In addition, field 208 of row 212C includes a first counter value CVAL_2 which indicates the response time of Edge™ and field 210 of row 212C includes a tag that is generated based on CVAL_2 and the CPU utilization value, which indicates that hardware configuration HW_3 has a slow response time with respect to Edge™. In addition, in field 208, row 212D identifies specific hardware components and/or component specifications that make up hardware configuration HW_3.

FIG. 2B shows an example of a table 200B. Table 200B may be a database table that is stored in database 107 and/or a table that is compiled by manager 105 by querying database 107. In the example of FIG. 2B, each of the rows in table 200B identifies a list of software applications that are executed on a different one of hardware configurations HW_1, HW_2, and HW_3. Although not shown, table 200B may identify the activities associated with each application. For example, database 107 may include information that the activity associated with Word™ is word processing, the activity associated with Fortnite™ is gaming, and so forth.

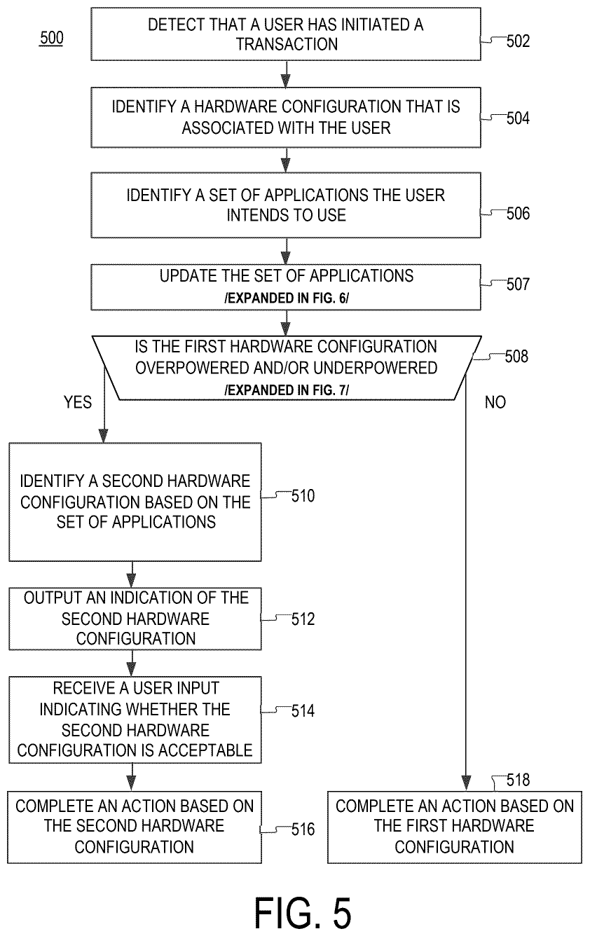

Engine 109 may be implemented in software, hardware, or as a combination of software and hardware. In one example, engine 109 may be configured to execute any of processes 500-800, which are discussed further below with respect to FIGS. 5-8C. Additionally or alternatively, in some implementations, engine 109 may include a generative machine learning model, such as Chat GP™ or Microsoft Co-Pilot™. The machine learning model may be trained on any information that is contained in database 107. The machine learning model may be trained to answer queries such as “Can you recommend a laptop for playing Fortnite, Call of Duty, Running Tensor Flow and Visual Studio?” or “Will this laptop be able to run Photoshop?”. Additionally or alternatively, the machine learning model may be trained to receive as input a list of applications which the user intends to run on a computer the user is looking to purchase, and output a hardware configuration for the computer, which is capable of running the application (i.e., without the hardware configuration being underpowered or overpowered). Additionally or alternatively, the machine learning model may be trained to receive as input a list of activities the user intends to perform on a computer the user is looking to purchase, and output a hardware configuration for the computer, which is capable of performing the activities (i.e., without the hardware configuration being underpowered or overpowered).

Additionally or alternatively, the machine learning model may be configured to receive as input an indication of a hardware configuration and a list of applications the user intends to run on the hardware configuration, and output an indication of whether the hardware configuration is suitable to running the applications. In one implementation, the output may have one of three possible values—the first value may indicate that the hardware configuration is underpowered for running the applications, the second value may indicate that the hardware configuration is an overkill (i.e., that the hardware configuration is excessively powerful for running the applications), and the third value may indicate that the hardware configuration is just right (i.e., adequate) for running the applications.

Additionally or alternatively, the machine learning model may be configured to receive as input an indication of a hardware configuration and a list of activities the user is intending to perform with the hardware configuration and output an indication of whether the hardware configuration is suitable to performing the activities. In one implementation, the output may have one of three possible values—the first value may indicate that the hardware configuration is underpowered for performing the activities, the second value may indicate that the hardware configuration is an overkill (i.e., that the hardware configuration is excessively powerful for performing the activities), and the third value may indicate that the hardware configuration is just right (i.e., adequate) for performing the activities.

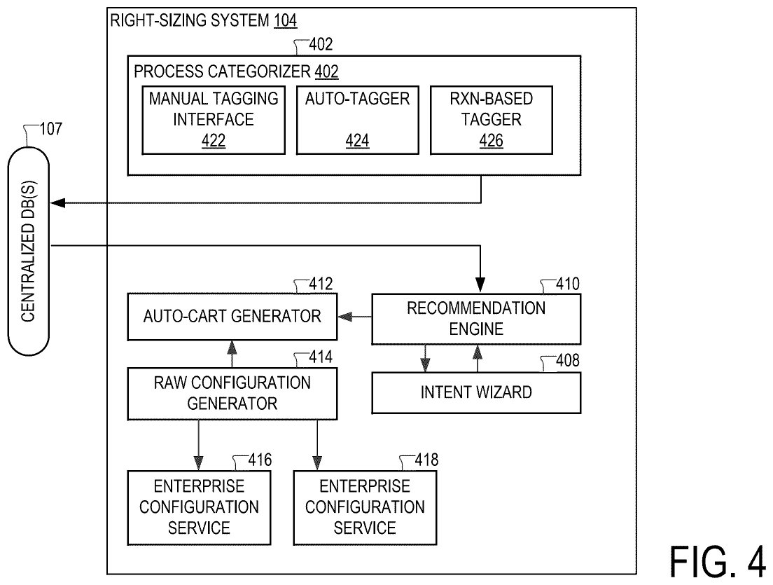

Additionally or alternatively, in some implementations, the machine learning model may include a neural network. The neural network may be trained using a training data set including a plurality of training data items. The neural network may be trained by using any suitable type of supervised learning algorithm. Each training data item may include an identifier of an application, an indication of a hardware configuration, an indication of any of the data that is collected for the hardware configuration, such as one or more resource consumption metrics for the application (e.g., CPU utilization rate, memory utilization rate, GPU utilization rate, network bandwidth consumed, etc.), an indication of the frequency at which the application crashes, an indication of one or more tags associated with the hardware configuration and application, an indication of one or more activities which the application is used for, and/or any other information that is collected by the agents 103 and/or manager 105 (e.g., see the discussion of FIGS. 3-4). In addition, each of the training data items may include a label indicating whether the hardware configuration is underpowered, overpowered, or adequate for running the application. During the inference stage, the neural network may receive as input an indication of the hardware configuration and an indication of a software application, and output an indication of whether the hardware configuration is underpowered, overpowered, or adequate for running the application. Additionally or alternatively, during the inference stage, the neural network may receive as input an indication of the hardware configuration and an indication of an activity which the user wants to user the hardware configuration for. In this example, the neural network may output an indication of whether the hardware configuration is underpowered, overpowered, or adequate for the activity.

The operation of manager 105 may yield the following advantages. In one aspect, manager 105 may prevent the user from purchasing underpowered or overpowered devices. In another aspect, manager 105 presents an alternative to purchasing a computing system based on an unsubstantiated perception (or guess) that the computing system is suitable for the user's needs. In another example, manager 105 may identify clusters of users that exist within an institution (e.g., a university or a corporation) and provide a specific configuration for each of the clusters, instead of the institution purchasing the same configuration for everyone. In this way, the exact needs of each cluster may be met more closely by the configuration. For example, the MBA students in a university may receive slower systems while the graphic design students may receive more powerful systems. In yet another aspect, manager 105 may maintain a self-evolving database (e.g., database 107) that is updated and maintained based on community usage. The database may be used to determine which hardware configurations can run what applications smoothly. In yet another aspect, manager 105 may account for users or institutions installing new software, which requires more computing resources.

In yet another aspect, manager 105 may provide the user with facilities for discovering the user's exact needs. For instance, manager 105 may make a suggestion for additional software which the user may have overlooked to list when submitting input to manager 105. A student planning on using a laptop for developing Visual Studio™, may yet be largely unaware of the fact that most developers who use that laptop for active web development using Visual Studio™ for example, also run Docker™. Having an intention-based interface, allows manager 105 to make users aware of these workloads that they may not have even considered and then provide them with the appropriate recommendations.

FIG. 3 shows an example of one possible implementation of agent 103, according to aspects of the disclosure. In the example of FIG. 3, agent 103 includes a process snapshot taker 302 (hereinafter “component 302”), an exclusion list 303 (hereinafter “component 303), a metadata extractor (hereinafter “component 304”), an inventory tracker 306 (hereinafter “component 306”), a log analyzer 308 (hereinafter “component 308”), a local database 310 (hereinafter “database 310”), and an uploader 312 (hereinafter “component 312”). FIG. 4 shows an example of one possible implementation of manager 105, according to aspects of the disclosure. In the example of FIG. 4, manager 105 includes a process categorizer (hereinafter “component 402”), an intent wizard 408 (hereinafter “component 408”), a recommendation engine 410 (hereinafter “component 410”), an auto-cart generator 412 (hereinafter “component 414”), an enterprise configuration service 416 (hereinafter “component 416”), and an enterprise cart solution (hereinafter “component 418”). Each of components 302-312 and 402-418 may be implemented in software, in hardware, or as a combination of software and hardware.

Component 302 may be a service written in any low-level programming language, such as RUST and C#which takes snapshots of a given device 102 that is executing agent 103. The snapshots may be taken periodically. For instance, the snapshots may be taken very N minutes (where N is a configurable parameter). Each snapshot may contain at least some of the following information: (1) all processes running on the given device 102 at any given point of time, (2) the processes' CPU consumption (Hz), RAM consumption (MB), Power Utilization (High/Medium/Low), Process executable name, and (3) brand, family, and model of the given device 102.

Additionally or alternatively, at least some of the snapshots taken by component 302 may include an identification of the CPU model or frequency of the given device 102, the type and amount of random-access memory (RAM) that is part of the given device 102, the type and size of permanent storage that is available to the given device, and modules, options, and selections for these devices. In other words, at least some of the snapshots may include an indication of the hardware configuration of the given device 102. In some implementations, this information (i.e., the hardware configuration information) may be included in the first snapshot that is generated by component 302. Additionally or alternatively, this information may be included in fewer than all snapshots that are taken by component 302.

Additionally or alternatively, at least some of the snapshots taken by component 302 may include a plurality of process metadata sets. Each metadata set may include one or more metadata items. Each metadata set may correspond to a different process or application that is running on the given device 102. Each metadata set may include process metadata extracted from the executable file for the metadata set's corresponding process. The process metadata may include one or more of a digital signature associated with the executable, manufacturer name for the application or process, full application name, version of the specific application/process, and so forth. This will form the foundation of the application inventory for the given device 102 which will be stored in the database for further analysis. Under the nomenclature of the present disclosure, the application inventory is also referred to as “application. In some implementations, this information (i.e., the process metadata) may be included in the first snapshots that is generated by component 302. Additionally or alternatively, this information may be included in fewer than all snapshots that are taken by component 302. Any time a snapshot is taken, if a new executable is found on the given device 102, the snapshot may be updated to include a metadata set for the new application.

Any of the snapshots may include various metrics indicating how a respective application is executing on the given device. Such metrics may include CPU time consumption of the respective application, memory consumption of the respective application, and so forth. In addition, the metrics may include various counter values that are provided by application programming interfaces (APIs) within the respective application, such counter values may include the response time of the program with respect to a particular application, errors that are generated within the program, and so forth. The metric values may be consolidated into various statistics, such as statics for the worst run of a respective application, the best run of the respective on the given device 102, and the median run of the respective application.

All snapshots that are generated by component 302 may be stored in local database 310 and subsequently uploaded to database 107.

Component 304 may be configured to identify a plurality of applications or processes that are executed (or otherwise installed) on the given device 102 and extract (or generate) a respective metadata set for each of the applications or processes. Component 304 may be configured to gather a respective metadata set for any of the applications running on the given device 102 and provide the metadata set to component 302 for inclusion in one or more snapshots that are generated by component 302.

Component 306 may be configured to maintain an inventory list of all applications running on the particular hardware along with their corresponding metadata. Every time a new executable is identified in a snapshot taken by component 302, component 306 may be updated to include extracted metadata that includes additional information about the new executable. Any information that is present in component 306 may be periodically uploaded to database 107. The metadata set for any application may include one or more metadata items that are embedded in the executable file for that application, such as “file version, product name, product version, size, data modified, original filename, application type, and application description.” In the Windows™ operating system, this information may be viewed in Explorer™, by right-clicking on the application file name.

Component 303 may be a list of applications and processes that are exempt from being recorded. Examples of such applications or processes operating system applications e.g., services, notepad, paint, etc., which are expected to run by default on any device that is Windows-compatible. Component 303 may be used to reduce the amount of data that manager 105 has to collect.

Component 308 may examine system logs 307 of the given device 102 to identify executables that are often crashing or not running well on the given device 102. Such executables may not show up the snapshots that are taken by component 302. This is why component 308 may periodically scan system logs 307 for any crashes to find out which executables crash. If any respective application found to be crashing frequently (e.g., more than N times a week, where N is a positive integer), the inventory list maintained by component 306 may be updated to include a flag that the application is unstable or otherwise has the tendency to crash or is otherwise unstable. In addition, the inventory list maintained by component 306 may be updated to identify the number of crashes the application experienced, which helps manager 105 to detect how reliably the application runs on the given device. If the crashing executable is not present in the inventory tracker manager 105 may update the inventory tracker to include the executable along with a flag containing the number of crashes the executable experienced on the device.

Local database may 307 be configured to store any information that is collected by components of agent 103. For example, local database 310 may be configured to store the inventory list of component 306 and/or any of the snapshots collected by component 302. The present example assumes that all metadata collected by component 304 is included in the snapshots generated by component 302. However, when this is not the case, the data not included may be stored in local database 310, as well. Component 312 may be configured to synchronize the state of local database 310, such that any data that is stored in local database 310 is subsequently copied to database 107.

Component 402 may include a manual tagging interface 424 (hereinafter “component 424), an auto-tagger 426 (hereinafter “component 426”), and a relationship-based tagger (hereinafter “component 426”). Although component 402 is depicted as being part of manager 105 (which is executed on system 104), in some implementations parts of component 402 may be executed on each of devices 102 and other parts may be executed on system 104.

Component 422 may enable manual tagging where moderators (or the user) can classify a specific application from a unique/distinct list of applications as a “gaming”, “finance”, “productivity” etc. application and apply those tags. In other words, component 422 may include a user interface for receiving user input that identifies the activity that an application can be used to perform and/or the values of other tags associated with the application. Examples of activities that might be associated with an application include productivity”, “office”, “student”, “gaming”, “design” “video editing”, etc. Component 422 may be executed on any of client devices 102 and/or system 104. When executed on any of client devices 102, component 422 may receive input from the user of the client device. Any information that is provided to component 422 may be stored in local database 310 and subsequently copied to database 107. When component 422 is executed on system 104, component 422 may receive input from a system moderator, and any information that is received at component 422 may be stored in database 107 directly.

Component 426 may be executed on any of devices 102 and it may be configured to perform auto-tagging. Auto-tagging may happen at a basic level where each row in the inventory list of component 306 is tagged with information such as application name, manufacturer name, data fetched from the central system for the same executable that may have been manually tagged in the past. This ensures that an executable once tagged is always recognized with those tags as new tags are applied to it.

Component 426 may be executed on system 104. Component 426 may be configured to identify relationships between applications. Specifically, component 426 may identify pairs of applications that are related. The applications may be ones that are listed in any of the rows of table 200B (shown in FIG. 2B). In one example, two applications may be considered related when a predetermined percentage (e.g., 80%) of the lists (or rows) in the table 200B contain identifiers of both applications. For any first application in table 200B, component 426 may identify one or more other second applications that are related to this application. For each second application, component 426 may generate a tag identifying a second application and store the tag in database 107 and/or table 200A. For example, the tag may be stored in a row in table 200A that contains an identifier of the first application in field 202. For example, Visual Studio code might be tagged with #also_used_with_docker and vice versa. This allows manager 105 to perform upselling. In a flow where the user expresses their intention to run Visual Studio™ code and is looking to buy a laptop that works best with Visual Studio™, manager 105 can ask them if they would also be interested in running Docker™ since most people who use Visual Studio™ also run Docker™.

Component 408 may include a chatbot or a structured front end capable of answering questions and other queries. Component 408 may interact with the user and also provide them with upselling recommendations. For example, if the user is looking for a laptop that can run VS Code, component 408 may detect that 76% of people who use vs-code also use docker containers on their machine and ask the user if they might be interested in buying a laptop that can also run docker containers well. Based on the user's selection and configuration, component 408 can be used to add a pre-configured product to shopping cart 122 (shown in FIG. 1).

Component 408, in the present example, is just a front end. For upsizing recommendations and other recommendations, component 408 uses component 410. Component 410 is configured to access and process data that is stored in database 107 to provide recommendations for a particular hardware configuration. For example, component 408 may receive a list of applications that the user intends to run. Next, component 408 may search database 107 to identify a hardware configuration that can run the applications adequately.

Component 414 may be configured to process transactions associated with institutional clients. When a transaction is started on behalf of an institution (e.g., when a representative of the institution accesses a page that is provided by interface 124 of system 120), component 414 may search database 107 to identify a plurality of hardware configurations associated with the institution. Next, component 414 may retrieve, from database 107, a different respective application set for each application. Next, component 414 may cluster the application sets based on the distance between different pairs of application sets. In one implementation, the distance between two application sets may be equal to the number of applications that are a member of either one of the two application sets, but not of the other. And finally, component 414 may generate a plurality of composite sets. Each composite set may be generated based on a different cluster of application sets. Each composite set may be generated by taking the union (or intersection) of the application sets in the composite set's corresponding cluster or otherwise combining the application sets. Each of the composite application sets may correspond to a different sub-group within an institution. For instance, when the university is an institution, one of the application sets may correspond to MBA students and another one may correspond to graphic design students. Component 416 may identify a different respective hardware configuration for each of the composite application sets, which has the capability to run adequately the applications in the composite set. Component 418 may store an indication of each of the identified hardware configurations in shopping cart 122 or another component of system 120.

FIG. 5 is a flowchart of an example of a process 500, according to aspects of the disclosure. According to the present example, process 500 is performed by manager 105. However, alternative implementations are possible in which process 500 is performed by another entity.

At step 502, manager 105 detects an event associated with a transaction. The event may be an event that is generated when a user accesses a specific product page in system 120, an event that is generated when the user adds a hardware configuration to shopping cart 122, an event that is generated when the user opens up a product customization page that is part of user interface 124, and/or any other suitable type of event.

At step 504, manager 105 identifies a first hardware configuration that is associated with the user. In one example, the first hardware configuration may be a hardware configuration that is added by the user to the shopping cart 122, a hardware configuration that is generated for the user by a system 120, a hardware configuration that the user has purchased previously, a hardware configuration that is associated with the user in database 107, and/or any other suitable type of hardware configuration.

At step 506, manager 105 identifies a set of applications that the user intends or is likely to use. The set of applications may be submitted by the user as user input. Additionally or alternatively, the set of applications may be retrieved from database 107. The retrieval may be performed by using an identifier associated with the user as a search key. Additionally or alternatively, the set of applications may be a composite set of applications that is generated in the manner discussed above with respect to component 414.

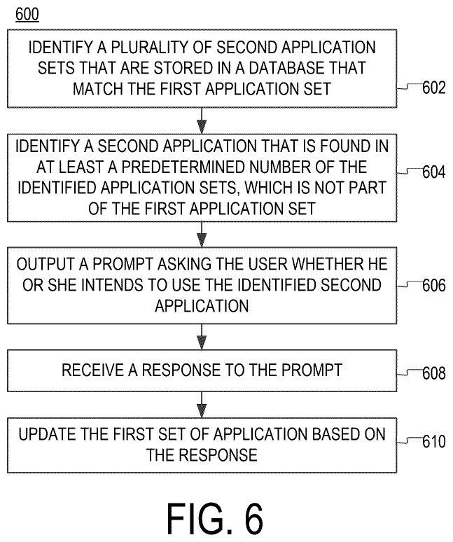

At step 507, manager 105 updates the set of applications. In some implementations, step 507 may be performed by executing a process 600, which is discussed further below with respect to FIG. 6. Although, in the present example, manager 105 detects whether the first hardware configuration is overpowered, in some implementations, manager 105 may additionally (or alternatively) determine whether the first hardware configuration is underpowered.

At step 508, manager 105 determines if the first hardware configuration is overpowered. In some implementations, the determination may be made by executing a process 700, which is discussed further below. If the first hardware configuration is found to be overpowered, process 500 proceeds to step 510. Otherwise, process 500 proceeds to step 518.

Additionally or alternatively, at step 508, manager 105 may determine if the first hardware configuration is underpowered. If the first hardware configuration is found to be overpowered, process 500 proceeds to step 510. Otherwise, process 500 proceeds to step 518.

At step 510, manager 105 identifies a second hardware configuration that is adequate for running the set of applications. According to the present disclosure, a hardware configuration is adequate for running a set of applications if the hardware configuration is neither overpowered nor underpowered with respect to any of the applications in the set. According to the present example, the second configuration is less powerful than the first configuration. Under the nomenclature of the present disclosure, a given hardware configuration is less powerful than another hardware configuration if at least one of the following conditions is true: (i) the given hardware configuration has less processing power than the other hardware configuration (e.g., due to having a slower processor or less power graphics card), (ii) the given configuration has a smaller amount of RAM and/or slower RAM than the other hardware configuration, (iii) the given hardware configuration has less permanent storage than the other hardware configuration, etc. To identify the second hardware configuration, manager 105 may perform a search of database 107 to identify one or more of: (i) a type of processor that is capable of executing adequately all (or most) of the applications in the set, (ii) a type and/or amount of RAM that is capable of executing adequately all (or most) of the applications in the set, a type of graphics card that is capable of executing adequately all (or most) of the applications in the set. Afterwards, manager 105 may perform a search of a product database (not shown) to identify a product that possesses the identified hardware characteristics (i.e., a product that includes: the identified type of processor or a comparable processor, the identified type and amount of memory or a comparable type and amount of memory, and the identified graphics card or a comparable graphics card). Alternatively, manager 105 may use a product customization tool to generate a hardware configuration that possesses the identified hardware characteristics.

At step 512, manager 105 outputs an indication of the second hardware configuration.

At step 514, manager 105 receives user input indicating whether the second hardware configuration is acceptable to the user. If the second hardware configuration is acceptable, process 500 proceeds to step 516. Otherwise, process 500 proceeds to step 518.

At step 516, manager 105 completes an action by using the second hardware configuration. In some implementations, at step 516, manager 105 may add the second hardware configuration to shopping cart 122. Additionally or alternatively, at step 516, manager 105 may remove the first hardware configuration from shopping cart 122 and add the second hardware configuration to shopping cart 122 (in place of the first hardware configuration). Additionally or alternatively, at step 516, manager 105 may store an indication of the second hardware configuration in a data structure or memory location that is subsequently used by system 120 to complete a purchase of the second hardware configuration. Additionally or alternatively, manager 105 may remove from the data structure an indication of the first hardware configuration. In some implementations, the event detected at step 502 may signal that the user has started a process, which, if completed, would result in the user purchasing the first hardware configuration. In this regard, the action performed at step 515 may have the effect of diverting the process away from purchasing the first hardware configuration and towards purchasing the second hardware configuration.

At step 518, manager 105 completes an action by using the first hardware configuration. In some implementations, at step 518, manager 105 may add the first hardware configuration to shopping cart 122 or leave the state of shopping cart 122 unchanged if the first hardware configuration is already added. Additionally or alternatively, at step 516, manager 105 may store an indication of the second hardware configuration in a data structure or memory location that is subsequently used by system 120 to complete a purchase of the first hardware configuration.

FIG. 6 is a flowchart of an example of a process for updating a set of applications, as specified by step 507 of process 500. In the present example, the set of applications identified at step 507 is referred to as “the first set of applications.” At step 602, manager 105 performs a search of database 107 to identify a plurality of second application sets that correspond to the first application set. According to the present example, a second application set corresponds to a first application set if and only if the second application set contains N applications that are also found in the first application set, wherein N is a positive integer greater than or equal to 1. At step 604, manager 105 identifies a given application that is related to any of the applications in the first set of applications (identified at step 506). The given application may be an application that is contained in X of the second application sets but not in the first application set, wherein X is an integer greater than or equal to 1. Additionally or alternatively, the given application may be identified in the manner discussed above with respect to component 426. At step 606, manager 105 outputs a prompt asking the user whether he or she intends to use the given application. At step 608, manager 105 receives a response to the prompt. At step 610, manager 105 updates the set of applications on the prompt. Updating the set based on the user response includes adding the given application to the set when the user response indicates that the user intends to use the application and leaving the set of applications unchanged when the user response indicates that the user does not intend to use the given application.

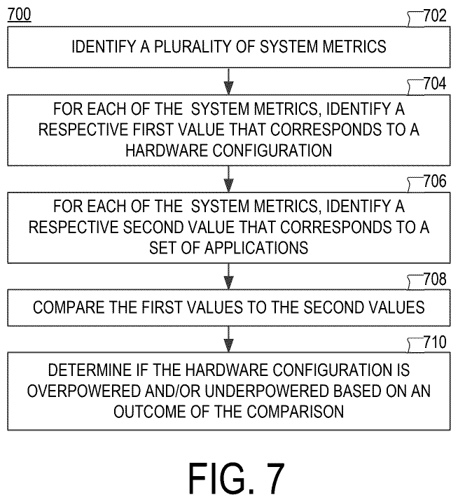

FIG. 7 is a flowchart of an example of a process 700 for detecting whether a hardware configuration is overpowered as specified by step 508 of process 500. At step 702, manager 105 identifies a plurality of system metrics. The identified system metrics may include one or more of a CPU type (e.g., a processor model), CPU speed, RAM type, RAM size, permanent storage type, permanent storage speed, and/or any other suitable type of system metric. At step 704, identifies a plurality of first values for the set of system metrics. Each of the first values may be a value of a different one of the system metrics. The first values may be retrieved from the first hardware configuration. At step 706, identifies a plurality of second values for the set of system metrics. Each of the second values may be a value of a different one of the system metrics. The second values may be retrieved by performing a search of database 107 to determine what values the system metric needs to have in order for each of the applications in the set (identified at step 506) to be executed adequately. At step 708, manager 105 compares the set of first values to the set of first values. At step 710, manager 105 determines if the first hardware configuration is overpowered based on an outcome of the comparison. For example, may determine if a comparison criterion is satisfied. If the criterion is satisfied, manager 105 may determine that the first hardware configuration is overpowered. Otherwise, if the criterion is not satisfied, manager 105 may determine that the first hardware configuration is not overpowered. In one example, the criterion may be satisfied if the first value for any of the system metrics exceeds the second value for the same system metric by a predetermined amount (e.g., 20%). In another example, the criterion may be satisfied if a predetermined number of the first values exceed their corresponding second values. According to the present example, a second value corresponds to a first value when both the first value and the second value are values for the same metric.

Although, in the present example, at step 710, manager 105 determines if the first hardware configuration is overpowered, manager 105 may additionally (or alternatively) determine if the first hardware configuration is underpowered. To do so, manager 105 may detect if any of the second values exceeds by a predetermined amount a corresponding first value (i.e., a value for the same metric as the second value). It will be understood that the present disclosure is not limited to any specific method for determining if a hardware configuration is underpowered or overpowered.

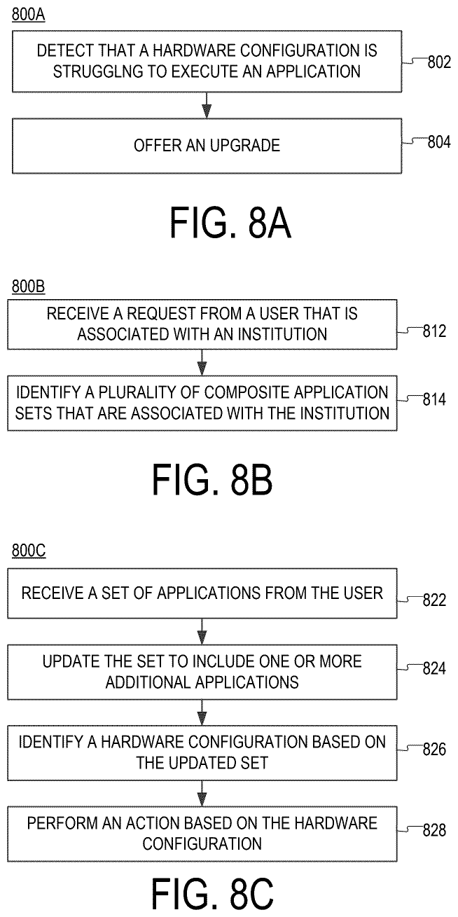

FIG. 8A is a flowchart of an example of a process 800A, according to aspects of the disclosure. At step 802, manager 105 detects that a hardware configuration is struggling to execute a software application. For example, manager 105 may detect that a hardware utilization metric of the application, such as CPU or memory utilization, exceeds a predetermined threshold. As another example, the manager 105 may detect that the frequency at which the application crashes exceeds a threshold. The software applicator may be a newly-installed application or a newly-installed application. At step 804, manager 105 offers the user of the hardware configuration an upgrade. Offering the upgrade may include transmitting a message to the hardware configuration which proposes to the user to replace a particular component in the hardware configuration with a new one, wherein the replacement would cause the hardware configuration to begin executing the software application adequately. For example, if manager 105 detects that the CPU utilization is too high, manager 105 may offer a CPU upgrade. Similarly if manager 105 detects that the application is crashing too frequently or has high memory consumption, manager 105 may offer a memory upgrade. Alternatively, offering the upgrade may include transmitting a message to the hardware configuration which proposes to the user to buy a new hardware configuration which is capable of executing the hardware application adequately.

FIG. 8B is a flowchart of an example of a process 800B, according to aspect of the disclosure. At step 812, manager 105 receives a request from a user who associated with an institution. In the present example, the institution is a university, but it in other instances the institution may be a corporation or another entity. At step 814, in response to the request, manager 105 identifies a plurality of composite application sets that are associated with the institutions. Each composite application set may identify the workload that is placed on university-provided laptops by a different subgroup of the university. For example, as noted above, one subgroup may consist of MBA students and another sub-group may consist of engineering students. Each of the composite application sets may be identified in the manner discussed above with component 414. For example, manager 105 may use database 107 to identify a plurality of hardware configurations that are associated with the university. Next, manager 105 may use database 107 to identify the application set that is running on each of the hardware configurations. Next, manager 105 may cluster the application sets into a plurality of clusters, such that the distance between any two application sets that are part of the same cluster is no more than X and the distance between any two application sets that are part of different clusters is at least Y, where X and Y are positive integers and X<Y. As noted above, the distance between two application sets may be equal to the number of application sets that that are part of one of the sets, but not the other, and/or in any other suitable manner. Afterwards, the application sets in each cluster may be combined (e.g., by taking the union of the application sets) to produce a composite application set. After the composite application sets are identified, manager 105 may output an indication of each of the composite application sets to the user. Additionally or alternatively, manager 105 may identify a plurality of hardware configurations, where each of the hardware configurations is identified based on a different one of the composite application sets. Each of the hardware configurations may be used to complete an action. By way of example, completing the action may include adding an indication of the hardware configuration to a shopping cart or adding an indication of the hardware configuration to a data structure that is subsequently used in the completion of a purchase.

FIG. 8C is a flowchart of an example of a process 800C, according to aspects of the disclosure. At step 822, manager 105, identifies a set of applications that are associated with a user. The set of applications may be received as user input. At step 824, manager 105 updates the set of applications. The set of applications may be updated in the manner discussed above with respect to FIG. 6. At step 826, manager 105 identifies a hardware configuration based on the updated application set. The hardware configuration may be identified by using the information stored in database 107. Identifying a hardware configuration based on a set of applications may include one or more of: (i) identifying a type of RAM that is needed to run each of the applications in the set adequately, (ii) identifying an amount of RAM that is needed to run on each of the applications in the set adequately, (iii) identifying an amount graphics memory that is needed to run each of the applications in the set adequately, (iv) identifying a type of graphics processing unit (GPU) that is needed to run each of the applications adequately, (v) identifying a type of central processing unit (CPU) that is needed to run each of the applications adequately, (iv) identifying a size of permanent storage that is needed to run each of the applications in the set adequately, and so forth. After the hardware configuration is identified at step 828, manager 105 performs an action based on the hardware configuration. The action may be performed in the manner discussed above with respect to step 516 or step 518 of process 500.

Examples are now provided of several use cases for manager 105.

Use Case 1: A student wants to buy a laptop for taking notes for his university studies and for playing Valorant™ (which is a computer game). Many of his fellow students are buying the latest Intel Core 19™ laptop. He is curious as to what would be the most economical purchase that would be able to achieve his requirements. He logs into manager 105 and enters the applications he needs to work with a generic natural language processing (NLP) based query, such as “I want to buy a laptop for taking notes, running MS Office and playing Valorant.” In response, manager 105 outputs an indication that the cheapest laptop where people have been successfully running the applications he needs effectively with 10% CPU still remaining idle is an 15, 10^{th} Gen CPU. Manager 105 then asks the student if they would like to add the pre-configured model of the laptop to his cart. The pre-configured model is useful because it has all the configuration required to run the student's workload, e.g., if the laptop comes with 4 GB, 8 GB and 16 GB RAM. After the student accepts to add the preconfigured model, the preconfigured model is added with 8 GB of RAM, which is sufficient to run the student's workload, with an option to increase it to 16 GB. This allows the student to save money, while also knowing the cheaper laptop the student is purchasing would be able to run the student's workload on sustainability. In addition, buying a cheaper (and less power-hungry laptop) would also have a positive impact on sustainability.

Use Case 2: A young developer who has just enrolled in engineering college interacts with manager 105 and enters, into manager 105, an indication that the user is looking for a laptop to write Visual Studio™ code with. Manager 105 performs a search of database 107 and discovers that 76% of the people who are running Visual Studio™ code are also running Docker™. While Visual Studio™ itself does not have a high resource requirement people running Docker™ often utilize high resources. Manager 105 outputs an indication to the young developer that most people who use Visual Studio code have used Docker™ at some point or other. Manager 105 then gives the young developer the option to choose if they will be using Docker™. If the young developer selects yes, they are provided with a higher configuration than they would have otherwise bought. This saves the young developer the trouble of buying an underpowered laptop and then later being dissatisfied with it.

Use Case 3: A university is running engineering and MBA batches. While they have been providing standardized laptops to all students. The university has agent 103 installed on their laptop. Using agents 103 and manager 105, the university discovers that while a bulk of the CPU is being utilized for running CAD/CAM applications by the engineering students, the MBA batches have been installing and playing high-end video games on their devices. Using manager 105, the university is able to roll out a completely different configuration for the MBA batches, compared to the engineering batches. Instead of one overarching configuration of 140 laptops, now two configurations of laptops are automatically added to the university quote, one with a lower-end configuration and another with a higher-end configuration both with a quantity of 70. Sales staff can then work with the university to further tweak this configuration with manual overrides.

Use Case 4: A university is considering a refresh of all computers in their cafeteria and libraries. Historically the university has been buying Intel Core 15™ desktops. The university has installed agent 103 on most (or many) of its computing devices and discovers that most of their workstations in the library are only used for browsing and running chrome, and downgrading to 13 CPUs will have no major impact. The university also discovers that since students rarely save anything on the hard drive, the university might be able to reduce the 1 TB configuration to a 250 GB drive and reduce the RAM from 16 GB to 8 GB on most desktops. Since there are over 50 desktops that need to be purchased, the university is able to save on considerable amount of money and also do the right thing from the point of sustainability.

Examples are now provided of advantages that manager 105 may yield to vendors of computing devices and clients (either institutional clients or individual clients):

Manager 105 may enable customers to reliably right-size their laptop purchase. As noted above, manager 105 enables users to use the real data of other users, with a friendly NLP-based user interface to answer any questions that they have about sizing their next upgrade/new purchase. This would mean happier customers who are being provided recommendations not just based on the latest and greatest laptops, but based on tailored specific intentions for which they are buying the laptop.

Manager 105 enables users to select a laptop that is guaranteed (or at least highly likely) to be able to perform the activities for which it is being purchased. A lot of questions that users are asking in support forums (e.g., Does this play Fortnite?) can all be directly answered with an intention-based FAQ chatbot (such as the generative machine learning model discussed above) that should be able to elegantly answer some of these questions based on data collected by agents 103.

Manager 105 enables intention-based upselling. As noted above, when the customer provides their intentions and workloads to manager 105, manager 105 may recommend additional workloads or intentions that they might be interested in. For example, when a student buys a mid-end laptop to run Visual Studio™ and later discovers that they need to run docker containers on the same device they may be disappointed with their purchase. In this regard, as noted above, manager 105 may be used to help the user discover that they would need to use docker containers and purchase a laptop that is adequate for this task.

The generative machine learning model that is part of manager 105 may be configured to answer various types of questions a user might have. While a user is buying a laptop, manager 105 can provide a dynamic “Top N applications that work best on this device” tab which is generated by using the data stored in database 107. This allows the users to see at a glance what applications are frequently executed on the laptop.

Manager 105 enables zero-touch solutions and quotes. Specifically, manager 105 may drastically reduce the time needed by a technical sales representative (TSR) to formulate a purchase recommendation for an institution, such as a university. As noted above, manager 105 may be used to identify different types of workloads that run on the computers of the institution and provide a different upgrade for each type of workload.

Referring to FIG. 9, in some embodiments, a device 900 may include processor 902, volatile memory 904 (e.g., RAM), non-volatile memory 906 (e.g., a hard disk drive, a solid-state drive such as a flash drive, a hybrid magnetic and solid-state drive, etc.), graphical user interface (GUI) 908 (e.g., a touchscreen, a display, and so forth) and input/output (I/O) device 920 (e.g., a mouse, a keyboard, etc.). Non-volatile memory 906 stores computer instructions 912, an operating system 916 and data 918 such that, for example, the computer instructions 912 are executed by the processor 902 out of volatile memory 904. Program code may be applied to data entered using an input device of GUI 908 or received from I/O device 920.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
identifying a first application set which a user intends to run on a hardware configuration;
identifying a first hardware configuration;
detecting whether the first hardware configuration is overpowered with respect to the first application set;
when the first hardware configuration is overpowered, identifying a second hardware configuration based on the first application set, and completing a first action based on the second hardware configuration; and
when the first hardware configuration is not overpowered, completing a second action based on the first hardware configuration.

2. The method of claim 1, wherein detecting whether the first hardware configuration is overpowered includes:
identifying a plurality of system metrics;
identifying a set of first values, each first value corresponding to a different one of the plurality of system metrics, each of the first values being part of the first hardware configuration;
identifying a set of second values, each of the second values corresponding to a different one of the plurality of system metrics, each of the second values being needed for executing the first application set adequately; and
comparing the set of first values to the set of second values; and
determining whether the first hardware configuration is overpowered based on an outcome of the comparison.

3. The method of claim 1, wherein completing the first action based on the second hardware configuration includes updating a data structure to include an indication of the second hardware configuration, the data structure being used by a sales system to complete a purchase of the second hardware configuration.

4. The method of claim 1, wherein completing the first action includes removing, from a shopping cart, an indication of the first hardware configuration and adding, to the shopping cart, an indication of the second hardware configuration.

5. The method of claim 1, further comprising:
identifying a plurality of second application sets that each include a predetermined number of applications in common with the first application set;
identifying an application that is part of a predetermined number of the second application sets, but not of the first application set; and
adding the identified application to the first application set, the identified application being added before the first application set is used to identify the second hardware configuration.

6. The method of claim 1, wherein identifying the first application set includes:
identifying a plurality of second hardware configurations that are associated with an institution;
identifying a plurality of second application sets, each of the second application sets being executed on a different one of the plurality of second hardware configurations;
clustering the plurality of second application sets to produce a plurality of clusters;
combining the second application sets in any of the clusters to produce a composite application set, the composite application set being the first application set.

7. The method of claim 6, wherein the institution includes one of a university or a corporation.

8. The method of claim 1, wherein identifying the first application set includes receiving a user input that specifies the first application set.

9. The method of claim 1, wherein the second hardware configuration identifies at least one of a type of processor and a random-access memory size.

10. The method of claim 1, wherein the second hardware configuration is identified by using a machine learning model that is trained based on information collected by a plurality of agents, each agent being executed on a different user device, the information collected by any given one of the agents including an indication of a respective hardware configuration of the user device executing the given agent, an indication a second application set, the second application set including applications that are running on the user device executing the given agent, and an indication of whether any of the applications in the second application set are executed adequately.

11. A method comprising:
identifying a plurality of first hardware configurations that are associated with an institution;
identifying a plurality of application sets, each of the application sets being executed on a different one of the plurality of first hardware configurations;
clustering the plurality of application sets to produce a plurality of clusters;
combining the application sets in any of the clusters to produce a composite application set;
identifying a second hardware configuration based on the composite application set; and
completing an action based on the second hardware configuration.

12. The method of claim 11, wherein the second hardware configuration identifies at least one of a type of processor and a random-access memory size.

13. The method of claim 11, wherein completing the action based on the second hardware configuration includes updating a data structure to include an indication of the second hardware configuration, the data structure being used by a sales system to complete a purchase of the second hardware configuration.

14. The method of claim 11, wherein completing the action based on the second hardware configuration includes adding the second hardware configuration to a shopping cart.

15. The method of claim 11, wherein the institution includes one of a university or a corporation.

16. A method, comprising:
identifying a first application set;
identifying a plurality of second application sets that each include a predetermined number of applications in common with the first application set;
identifying an application that is part of a predetermined number of the second application sets, but not of the first application set;
adding the identified application to the first application set;
identifying a hardware configuration based on the first application set; and
completing an action based on the hardware configuration.

17. The method of claim 16, wherein the hardware configuration identifies at least one of a type of processor and a random-access memory size.

18. The method of claim 16, wherein completing the action based on the hardware configuration includes updating a data structure to include an indication of the hardware configuration, the data structure being used by a sales system to complete a purchase of the hardware configuration.

19. The method of claim 16, wherein completing the action based on the hardware configuration includes adding the hardware configuration to a shopping cart.

20. The method of claim 16, wherein the hardware configuration is identified by using a machine learning model that is trained based on information collected by a plurality of agents, each agent being executed on a different user device, the information collected by any given one of the agents including an indication of a respective hardware configuration of the user device executing the given agent, an indication a third application set, the third application set including applications that are running on the user device executing the given agent, and an indication of whether any of the applications in the third application set are executed adequately.
